(19) United States
(12) Patent Application Publication
(10) Pub. No.: US 2010/0138572 A1
(43) Pub. Date: Jun. 3, 2010

(54) UNIVERSAL SERIAL BUS DEVICE WITH MILLIMETER WAVE TRANSCEIVER AND SYSTEM WITH HOST DEVICE FOR USE THEREWITH

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/326,267

(22) Filed: Dec. 2, 2008

(51) Int. Cl. G06F 13/42

(52) U.S. Cl. 710/106

(57) ABSTRACT

A universal serial bus device includes a wireless millimeter wave transceiver that communicates first data with a host device via a first RF millimeter wave communication path. A USB interface, when coupled to a host device, communicates second data with the host device.

### CROSS-REFERENCE TO RELATED APPLICATIONS

None

### BACKGROUND OF THE INVENTION

1. Technical Field of the Invention

This invention relates generally to universal serial bus devices and integrated circuits used therein.

2. Description of Related Art

Communication systems are known to support wireless and wire lined communications between wireless and/or wire lined communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, RFID, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

In most applications, radio transceivers are implemented in one or more integrated circuits (ICs), which are inter-coupled via traces on a printed circuit board (PCB). The radio transceivers operate within licensed or unlicensed frequency spectrums. For example, wireless local area network (WLAN) transceivers communicate data within the unlicensed Industrial, Scientific, and Medical (ISM) frequency spectrum of 900 MHz, 2.4 GHz, and 5 GHz. While the ISM frequency spectrum is unlicensed there are restrictions on power, modulation techniques, and antenna gain.

Many devices such as computers, cameras, personal digital assistants and memory devices include wired connections. An example of such a wired connection is a universal serial bus (USB) connection, the operation of which is governed by several standards.

The disadvantages of current and conventional approaches will become apparent when compared with the present invention after review of the following detailed description of the invention made with reference to the accompanying drawings.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a communication system in accordance with the present invention;

FIG. 2 is a schematic block diagram of an embodiment of another communication system in accordance with the present invention;

FIG. 3 is a schematic block diagram of an embodiment of RF transceiver 135 in accordance with the present invention;

FIG. 4 presents a pictorial representation of a USB dongle device 5 in accordance with an embodiment of the present invention;

FIGS. 5-8 present pictorial representations of USB dongle device 5 and a cap 6 in accordance with an embodiment of the present invention;

FIG. 9 presents a pictorial representation of a USB/wireless network 80 in accordance with an embodiment of the present invention;

FIG. 10 is a schematic block diagram showing the possible interconnection between a USB device 83 and host device 82 in accordance with an embodiment the present invention;

FIG. 11 is a schematic block diagram showing the possible interconnection between a USB device 84 and host device 82 in accordance with an embodiment the present invention;

FIG. 12 is a schematic block diagram showing the possible interconnection between a USB device 85 and host device 82′ in accordance with an embodiment the present invention; and

FIG. 13 is a schematic block diagram showing the possible interconnection between a USB device 86 and host device 82 in accordance with an embodiment the present invention.

### DETAILED DESCRIPTION OF THE INVENTION

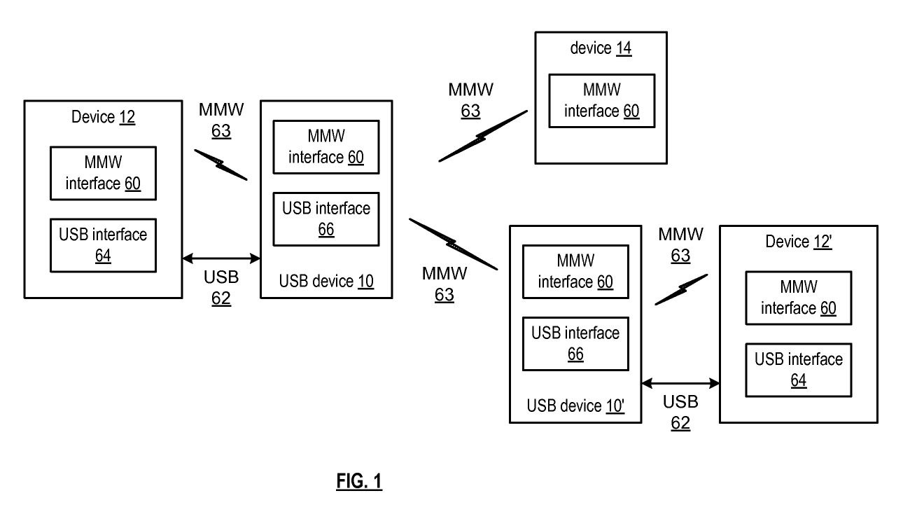

FIG. 1 is a schematic block diagram of an embodiment of a communication system in accordance with the present invention. In particular a communication system is shown that includes a USB device 10 that can communicate real-time or non-real-time data with a host device 12 via a USB connection 62 and a wireless millimeter wave communication path 63. In addition, USB device 10 can optionally communicate via the millimeter wave communication path 63 with other devices such as the direct communication with device 14 or an indirect communication with another host device 12′ via a similar USB device 10′.

In an embodiment of the present invention, the USB device 10 includes a wireless millimeter wave transceiver 60 that communicates first data with a host device, such as device 12, via a first RF millimeter wave communication path, such as millimeter wave communication path 63. USB interface 66, when coupled to a complementary USB interface 64 of the host device, communicates second data with the host device. This provides multiple communication paths, a millimeter wave wireless path and a USB path, between the USB device 10 and the host device, such as device 12. The USB path can be used to establish, configure or reconfigure the millimeter wave path between the USB device 10 and the host device. For instance, the USB connection between USB device 10 and device 12 can serve as a secure conduit for sensitive information, such as passwords, user IDs, encryption keys and/or other security information. In this fashion, the USB connection can be used to establish a secure connection, between the two devices. Alternatively, the two communication paths can be used to complement one another for the transfer of data between USB device 10 and device 12. Further, the USB device 10 can function as a portal for communicating with other devices via the millimeter wave path.

While described in as a USB connection 62, this wireline connection can, in other embodiments, be a wired connection that operates in accordance with one or more standard protocols, Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless millimeter wave path can operate in accordance with a wireless communication protocol in a 60 GHz frequency band. In other embodiments, other wireless communication paths can be employed that communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary over a frequency band such as a 800 MHz, 900 MHz, 2.4 GHz, 5.8 GHz, or other frequency band. Further, the wireless communication path can include separate transmit and receive paths that use separate carrier frequencies and/or separate frequency channels. Alternatively, a single frequency or frequency channel can be used to bi-directionally communicate data to and from the USB device 10.

USB devices 10 and 10′ can each be a USB dongle device such as a memory device or bridge device, or other USB device such as a keyboard, printer, mouse, a camera, a mobile phone such as a cellular telephone, a personal digital assistant, game console, game device, personal computer, laptop computer, or other device that performs one or more functions that include communication of voice and/or data via USB connection 62 and/or the millimeter wave communication path 63. In an embodiment of the present invention, device 12 and 12′ can be personal computers, laptops, PDAs, mobile phones, such as cellular telephones, devices equipped to communicate via USB connection 62 and/or the millimeter wave communication path 63. Device 14 can be any wireless device equipped to communicate via the millimeter wave communication path 63.

In operation, the device 12 includes one or more applications that include voice communications such as standard telephony applications, voice-over-Internet Protocol (VoIP) applications, local gaming, Internet gaming, email, instant messaging, multimedia messaging, web browsing, printing, security, e-commerce, audio/video recording, audio/video playback, audio/video downloading, playing of streaming audio/video, office applications such as databases, spreadsheets, word processing, presentation creation and processing and other voice and data applications. In conjunction with these applications, the data communicated with USB device 10 can include voice, audio, video and multimedia data including gaming data, image data, text, email, web data, security data, control data and other data.

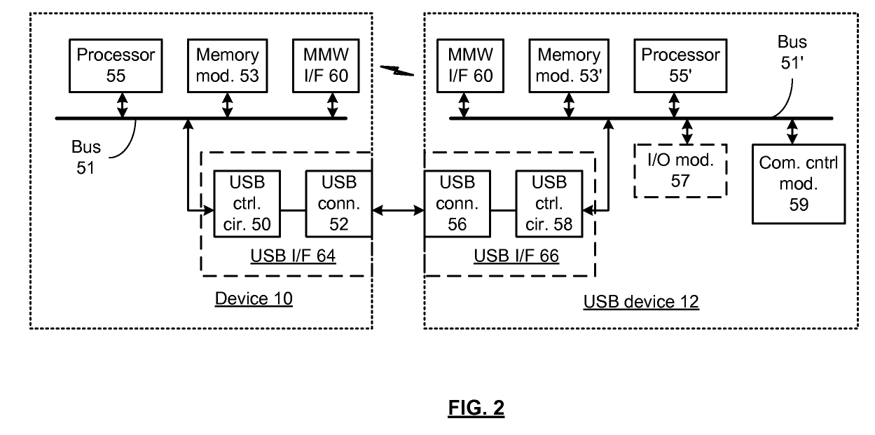

FIG. 2 is a schematic block diagram of an embodiment of another communication system in accordance with the present invention. In particular, USB device 12 includes a USB interface 66, millimeter wave interface 60, a bus 51′, a processor 55′ and memory module 53′ a communication control module 59 and an optional input/output (I/O) module 57. As discussed in conjunction with FIG. 1, USB device 10 can be a USB dongle device such as a memory device or bridge device, or other USB device such as a keyboard, printer, mouse, a camera, a mobile phone such as a cellular telephone, a personal digital assistant, game console, game device, personal computer, laptop computer, or other device. Processor 55′ can operate in conjunction with memory module 53′ to execute one or more applications of USB device 12 in conjunction with the particular functionality of the device. Further USB device 12 can optionally include additional modules, not expressly shown for performing the functions of the device.

I/O module 57, in operation, can generate data based on actions of a user of USB device 12 and/or operate based on data received from device. I/O module 57 can include a microphone, keypad/keyboard, speaker, display, camera element, along with appropriate encoders and decoders for communicating via the USB interface 66 and/or the millimeter wave interface 60, a codec for encoding voice signals from a microphone into digital voice signals, a keypad/keyboard interface for generating data from a keypad/keyboard in response to the actions of a user, a display driver for driving a display, such as by rendering a color video signal, text, graphics, or other display data, and/or an audio driver such as an audio amplifier for driving a speaker and one or more other interfaces, such as for interfacing with a camera or the other I/O devices that are included in I/O module 57 or coupled thereto.

USB interface 66 includes a USB controller circuit 58 that formats the data bound for device 10 in a USB format by creating USB formatted packets with the outbound data as a payload. USB interface 66 further includes a USB connector 52, such as USB plug 6, other USB compatible plug or jack or other connector, for coupling to the device 10. Device 10 includes USB interface 64 that includes a USB connection 52 such as a USB jack for mating with the USB connector 56 either directly or through one or more cables. Device 10 further includes a USB controller circuit 50 that receives the outbound data from USB device 12 in the USB format and optionally strips the USB formatting and/or converts the data to another format for communication to processor 55 via bus 51. Processor 55 executes an application stored in memory 53 based on the data received from USB device 12.

Further, processor 55 can generate data that can be inbound to USB dongle device 12, in a reverse data path between the two devices, but in a similar fashion to the forward data path previously described, but with the functionality of USB interfaces 64 and 66 reversed. In this fashion, USB interfaces 64 and 66 can communicate bi-directionally. It should be noted that device 10, can include other devices, including user interface devices, peripheral interfaces, etcetera that are not shown.

In an embodiment of the present invention, the various modules of USB device 12 can be self powered by a battery or other power supply (not expressly shown) included in or coupled to the USB device 12. Further the various modules of USB device 12, including the wireless millimeter wave transceiver 60 and USB interface 66 can be powered by a current received from the device 10 via the USB interface 66.

Processors 55 and 55′ may each be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions such as one or more application, utilities, an operating system and/or other instructions. The memory modules 53 and 53′ may each be a single memory device or a plurality of memory devices that are either on-chip or off-chip. Such a memory device may be a read-only memory, random access memory, volatile memory, non-volatile memory, static memory, dynamic memory, flash memory, and/or any device that stores digital information. Note that when the USB device 12 and device 10 implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

While particular bus configurations are shown for device 10 and USB device 12, other bus configuration including multiple buses and/or direct connectivity between different devices can likewise be employed.

USB device 12 and device 10 each include a millimeter wave interface 60 for communicating data between the USB device 12 and device 10 via a millimeter wave communication path, such as millimeter wave communication path 63. In an embodiment of the present invention, the millimeter wave interfaces 60 communicate real-time or non-real-time data via a wireless link that operates in the 60 GHz band or other millimeter wave band. Further details regarding the operation of the millimeter wave interface will be presented in conjunction with the description beginning with FIG. 3.

Communication control module 59 operates to coordinate the communication between USB device 12 and device 10 via the millimeter wave interfaces 60 and USB interfaces 64, 66. In particular, communication control module 59 selectively routes outbound data as the first data in a first mode of operation and selectively routes the outbound data as the second data in a second mode of operation, based on the application being executed by processor 55, under command of the user of USB device 10 received via I/O module 57. In an embodiment of the present invention, the communication control module is implemented via software, hardware or firmware, such as via a process running on a shared or dedicted processor, such as processor 55′. In particular, communication control module can select a particular path for communication of outbound data to device 10 based on which communication path is currently connected, based on the data rate, security, protocol, format, quality of service required, or other attributes of the outbound data.

For example, communication control module 59 can select first data for communication between the memory module 53′ and the device 10 via the millimeter wave communication path 63. Input/output (I/O) module 57 can generate second data based on actions of a user that is selected by communication module 59 for transfer to device 10 via the USB interface 66. Conversely, communication control module 59 can select first data for communication between the memory module 53′ and the device 10 via the USB interface 66. Input/output (I/O) module 57 can generate second data based on actions of a user that is selected by communication module 59 for transfer to device 10 via the USB interface 66 millimeter wave communication path 63. In another example, communication control module 59 can split data from the memory module 57, with a first portion of the data transferred to device 10 via the millimeter wave communication path 63 and a second portion of the data transferred to device 10 via the USB connection. Further, the communication control module 59 can coordinate communications between the two communications paths to have one of the paths be a forward path and the other a reverse path between the two devices, one path used for the communication of control information, such as acknowledgements, configuration data, and other control data, etc.

In an embodiment of the present invention, communication control module 59 establishes at the millimeter wave communication path 63 between the device 10 and the USB device 12 based on the exchange of data over the USB connection between the two devices. In particular, configuration data for the millimeter wave communication path 63, such as data rates, protocols, modulation parameters, power levels, channels and/or frequency bands can be set, negotiated or otherwise determined between the device 10 and the USB device via data exchanged over the USB connection. In addition, the security of the wired USB connection can be employed to exchange security data, such as device registration data, password data, user identification data, an encryption key, and an encryption parameter or other security data used to secure the communication between the USB device 12 and device 10 via the millimeter wave interfaces 60 or otherwise to authenticate the association between the USB device 12 and device 10.

In a further mode of operation, the USB device 12 operates as a bridge device/USB hub to communicate data received via the USB interface 66 to other remote devices such as devices 10′ or 14 via another millimeter wave path 63. In a similar fashion, data received from remote devices such as devices 10′ or 14′ via another millimeter wave communication path 63 can be transferred to device 10 via the USB interface 66.

For example, a USB device 12, such as a USB keyboard, mouse, camera or printer can be coupled to a device 10, such as a laptop computer, for providing input/output functionality. When the USB device 12 is connected to the laptop computer via the USB connection 62, the laptop computer provides security data, such as device registration data and an encryption key that can be used by the USB device 12 for communication with the laptop computer via the millimeter wave path 63. In an embodiment of the present invention, the USB connection can be severed and the peripheral device can communicate wirelessly with the device 10 via the millimeter wave communication path 63. In this fashion, a peripheral device can be connected to a computer via a USB connection to engage in registration of the device. Then, when the peripheral device is disconnected, the peripheral device can securely communicate with the computer via the security data exchanged during the registration process.

FIG. 3 is a schematic block diagram of an embodiment of RF transceiver 135 in accordance with the present invention. The RF transceiver 135, such as millimeter wave interface 60, includes an RF transmitter 139, and an RF receiver 137. The RF receiver 137 includes a RF front end 140, a down conversion module 142 and a receiver processing module 144. The RF transmitter 139 includes a transmitter processing module 146, an up conversion module 148, and a radio transmitter front-end 150.

As shown, the receiver and transmitter are each coupled to an antenna through an off-chip antenna interface 171 and a diplexer (duplexer) 177, that couples the transmit signal 155 to the antenna to produce outbound RF signal 170 and couples inbound signal 152 to produce received signal 153. Alternatively, a transmit/receive switch can be used in place of diplexer 177. While a single antenna is represented, the receiver and transmitter may share a multiple antenna structure that includes two or more antennas. In another embodiment, the receiver and transmitter may share a multiple input multiple output (MIMO) antenna structure, diversity antenna structure, phased array or other controllable antenna structure that includes a plurality of antennas. Each of these antennas may be fixed, programmable, and antenna array or other antenna configuration. Also, the antenna structure of the wireless transceiver may depend on the particular standard(s) to which the wireless transceiver is compliant and the applications thereof.

In operation, the transmitter receives outbound data 162 that includes non-realtime data or real-time data from communication control module 59, processor 55 or 55′ or other portion of a device 10, 10′, 12, 12′ or 14 or other source via the transmitter processing module 146. The transmitter processing module 146 processes the outbound data 162 in accordance with a particular wireless communication standard that can include a cellular data or voice protocol, a WLAN protocol, piconet protocol or other wireless protocol such as IEEE 802.11, Bluetooth, RFID, GSM, CDMA, et cetera) to produce baseband or low intermediate frequency (IF) transmit (TX) signals 164 that includes an outbound symbol stream that contains outbound data 162. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 can include, but is not limited to, scrambling, encoding, puncturing, mapping, modulation, and/or digital baseband to IF conversion.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up-converted signals 166 based on a transmitter local oscillation.

The radio transmitter front end 150 includes a power amplifier and may also include a transmit filter module. The power amplifier amplifies the up-converted signals 166 to produce outbound RF signals 170, which may be filtered by the transmitter filter module, if included. The antenna structure transmits the outbound RF signals 170 to a targeted device such as a RF tag, base station, an access point and/or another wireless communication device via an antenna interface 171 coupled to an antenna that provides impedance matching and optional bandpass filtration.

The receiver receives inbound RF signals 152 via the antenna and off-chip antenna interface 171 that operates to process the inbound RF signal 152 into received signal 153 for the receiver front-end 140. In general, antenna interface 171 provides impedance matching of antenna to the RF front-end 140, optional bandpass filtration of the inbound RF signal 152 and optionally controls the configuration of the antenna.

The down conversion module 142 includes a mixing section, an analog to digital conversion (ADC) module, and may also include a filtering and/or gain module. The mixing section converts the desired RF signal 154 into a down converted signal 156 that is based on a receiver local oscillation 158, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156 that includes a inbound symbol stream. Note that the ordering of the ADC module and filtering and/or gain module may be switched, such that the filtering and/or gain module is an analog module.

The receiver processing module 144 processes the baseband or low IF signal 156 in accordance with a particular wireless communication standard that can include a specific millimeter wave protocol, cellular data or voice protocol, a WLAN protocol, piconet protocol or other wireless protocol such as IEEE 802.11, Bluetooth, RFID, GSM, CDMA, et cetera) to produce inbound data 160 that can include non-realtime data, realtime data and/or control data. The processing performed by the receiver processing module 144 can include, but is not limited to, digital intermediate frequency to baseband conversion, demodulation, demapping, depuncturing, decoding, and/or descrambling.

In an embodiment of the present invention, receiver processing module 144 and transmitter processing module 146 can be implemented via use of a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip. Such a memory device may be a read-only memory, random access memory, volatile memory, non-volatile memory, static memory, dynamic memory, flash memory, and/or any device that stores digital information. Note that when the these processing devices implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

While the processing module 144 and transmitter processing module 146 are shown separately, it should be understood that these elements could be implemented separately, together through the operation of one or more shared processing devices or in combination of separate and shared processing.

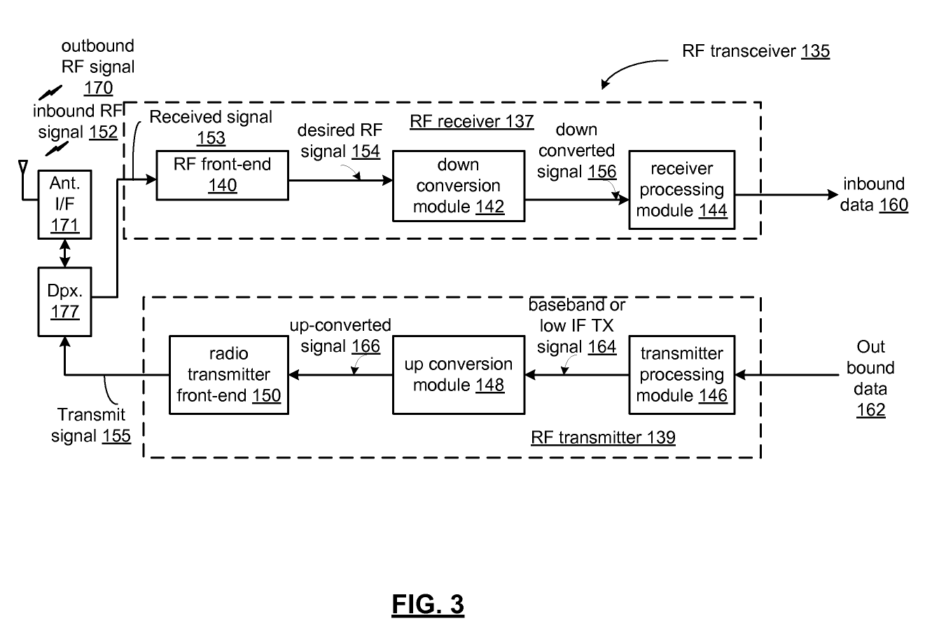

FIG. 4 presents a pictorial representation of a USB dongle device 5 in accordance with an embodiment of the present invention. In particular, a universal serial bus (USB) dongle device 5, such as USB device 12, is presented that includes a USB plug 4 and housing to enclose and support the internal circuitry that conforms to a USB flash drive form factor, however, other configurations and form factors could likewise be used in accordance with the present invention. USB dongle device 5 can be coupled to a host device, either directly by coupling the USB plug to a USB jack of the host device or via a USB cable. In an embodiment of the present invention, the internal circuitry of USB dongle 5 can be powered by a current/voltage received from the host device via the USB plug 4. In addition or in the alternative, the USB dongle device 5 can be self powered such as via one or more batteries or other power sources and/or may function as a USB on-the-go device. Indicator light 8 is included to indicate a power-up or otherwise operational state of the USB dongle device 5. While not shown, a more sophisticated user interface such as a LCD display or other display screen, one or more buttons, switches or thumb wheels or other user interface devices may also be included in, or coupleable to, USB dongle device 5 to take advantage of the functions and features of the invention.

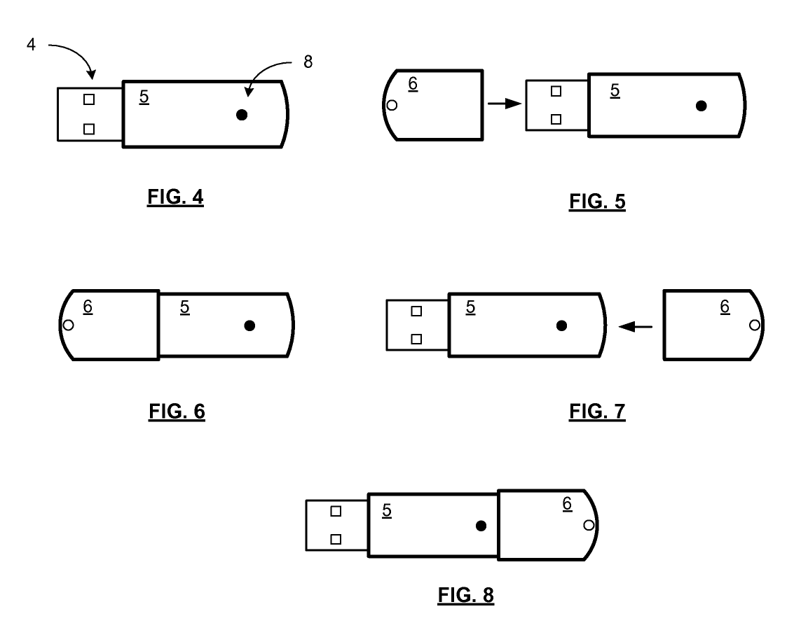

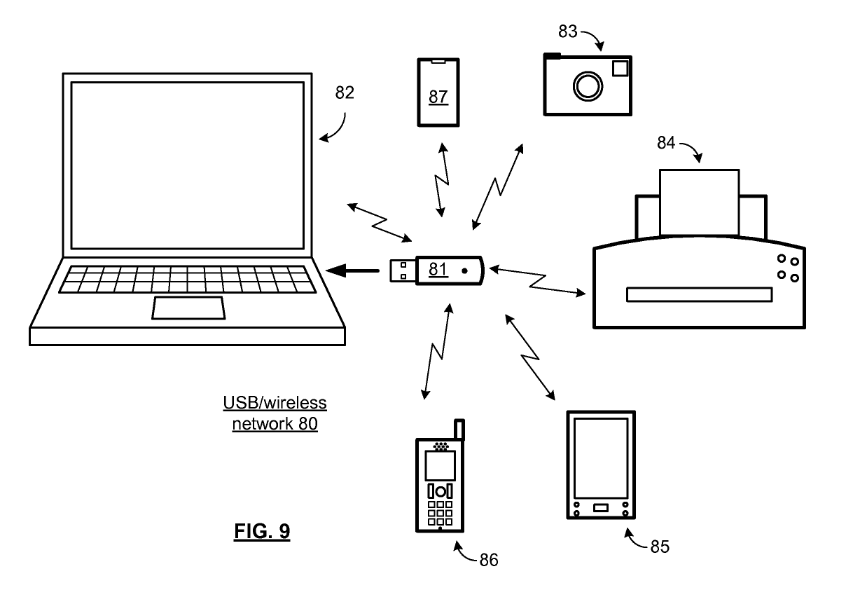

FIGS. 5-8 present pictorial representations of USB dongle device 5 and a cap 6 in accordance with an embodiment of the present invention. As shown in FIGS. 5 and 6, USB dongle device 5 includes a cap 6 that is couplable with the housing in a first position to cover the USB plug 4 when not in use. As shown, the cap includes an opening for accepting a key ring. In an embodiment of the present invention shown in FIGS. 7 and 8, the cap 6 is further couplable with the housing in a second position to store the cap 6 and to leave the USB plug 4 uncovered.

FIG. 9 presents a pictorial representation of a USB/wireless network 80 in accordance with an embodiment of the present invention. In particular, USB dongle device 81, such as USB dongle device 5 or USB device 12, includes a millimeter wave transceiver, such as millimeter wave interface 60. When coupled to a host device 82, such as device 10 via a USB connection and or a millimeter wave interface 60, USB dongle device 81 allows the host device to interface with other devices equipped with millimeter wave transceivers of their own such as camera 83, printer 84, personal digital assistant 85, wireless telephony device 86, or that otherwise communicate with the millimeter wave transceiver of USB dongle device 81, such as RFID device 87.

In an embodiment of the present invention, USB dongle device 81 acts as a wireless USB HUB to provide a wireless USB interface between devices over a frequency band such as a 60 GHZ band. In this fashion, USB formatted data packets can be transferred wirelessly between devices that do not require power to be supplied by the USB interface. In the alternative or in addition, USB dongle device 81 can operate as an RFID transceiver to communicate with one or more RFID tags or RFID devices that communicate by, for instance, modulating or backscattering the RF signals emitted by the RFID transceiver. Further the USB interface of USB dongle device 81 can be used merely to transfer data to and from the USB dongle device 81 and the host device 82. In this configuration data that is carried in inbound and outbound data to/from the USB dongle device 81 and the external devices in accordance with another protocol, either standard or proprietary.

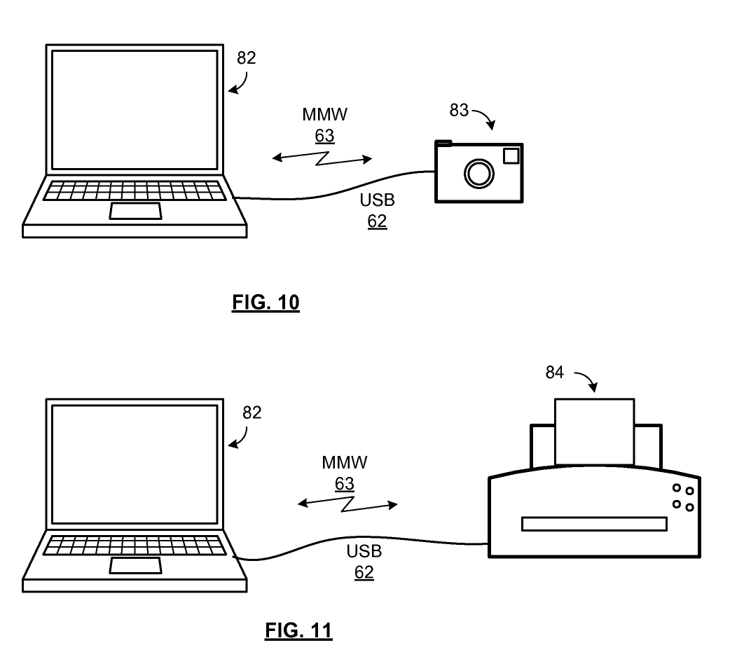

FIG. 10 is a schematic block diagram showing the possible interconnection between a USB device 83 and host device 82 in accordance with an embodiment the present invention. In particular, host device 82 is an example of device 10 and USB device 83, in this case is a camera that is an example of USB device 12. USB device 83 and host device 82 can communicate via a USB connection 62 and a millimeter wave communication path 63. As discussed in conjunction with FIG. 1, data exchanged between the USB device 83 and host device 82 can be transferred via either the USB connection 62, the millimeter wave communication path 63 or both.

FIG. 11 is a schematic block diagram showing the possible interconnection between a USB device 84 and host device 82 in accordance with an embodiment the present invention. In particular, host device 82 is an example of device 10 and USB device 84, in this case is a printer that is an example of USB device 12. USB device 84 and host device 82 can communicate via a USB connection 62 and a millimeter wave communication path 63. As discussed in conjunction with FIG. 1, data exchanged between the USB device 84 and host device 82 can be transferred via either the USB connection 62, the millimeter wave communication path 63 or both.

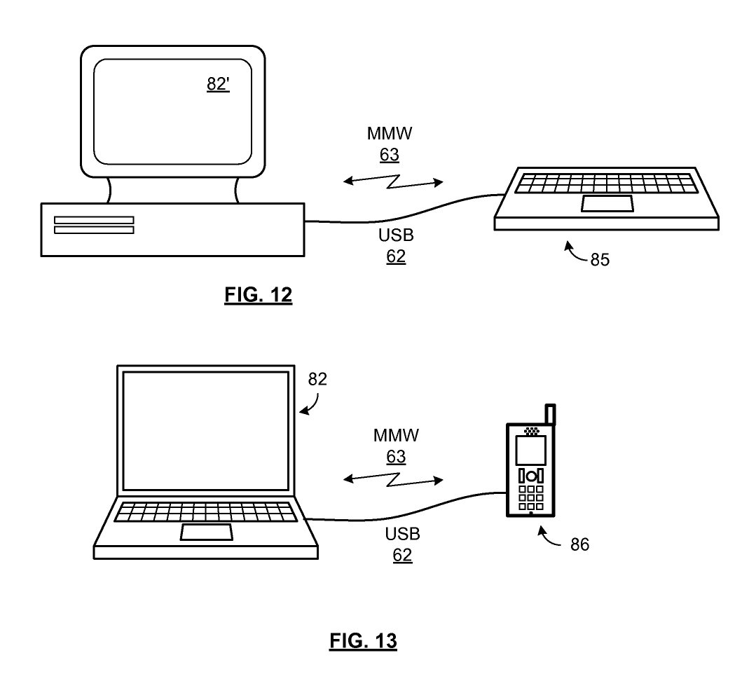

FIG. 12 is a schematic block diagram showing the possible interconnection between a USB device 85 and host device 82′ in accordance with an embodiment the present invention. In particular, host device 82′ is an example of device 10 and USB device 85, in this case is a keyboard that is an example of USB device 12. USB device 85 and host device 82′ can communicate via a USB connection 62 and a millimeter wave communication path 63. As discussed in conjunction with FIG. 1, data exchanged between the USB device 85 and host device 82′ can be transferred via either the USB connection 62, the millimeter wave communication path 63 or both.

FIG. 13 is a schematic block diagram showing the possible interconnection between a USB device 86 and host device 82 in accordance with an embodiment the present invention. In particular, host device 82 is an example of device 10 and USB device 86, in this case is a mobile phone that is an example of USB device 12. USB device 86 and host device 82 can communicate via a USB connection 62 and a millimeter wave communication path 63. As discussed in conjunction with FIG. 1, data exchanged between the USB device 86 and host device 82 can be transferred via either the USB connection 62, the millimeter wave communication path 63 or both.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A universal serial bus (USB) dongle device comprising:
a wireless millimeter wave transceiver that communicates first data with a host device via a first RF millimeter wave communication path; and
a USB interface, coupled to the first wireless millimeter wave transceiver that, when coupled to a host device, communicates second data with the host device.

2. The USB dongle device of claim 1 further comprising:
a communication control module, coupled to the USB interface and the wireless millimeter wave transceiver, that selectively routes outbound data as the first data in a first mode of operation and selectively routes the outbound data as the second data in a second mode of operation.

3. The USB dongle device of claim 1 further comprising:
a communication control module, coupled to the USB interface and the wireless millimeter wave transceiver, that establishes at the first RF millimeter wave communication path based on the second data.

4. The USB dongle device of claim 3 wherein the portion of the second data includes security data.

5. The USB dongle device of claim 3 wherein the security data includes at least one of: password data, user identification data, an encryption key, and an encryption parameter.

6. The USB dongle device of claim 3 wherein the portion of the second data includes configuration data.

7. The USB dongle device of claim 1 further comprising:
a memory module, coupled to the USB interface and the wireless millimeter wave transceiver, that stores third data.

8. The USB dongle device of claim 7 where in the third data includes a least one of: a portion of the first data; and a portion of the second data.

9. The USB dongle device of claim 1 wherein the wireless millimeter wave transceiver is further operable to communicate third data with a host device via a second RF millimeter wave communication path.

10. The USB dongle device of claim 1 wherein the second data are formatted in a USB format and the USB dongle device operates as a USB hub to communicate third data with a plurality of other devices via the wireless millimeter wave transceiver.

11. The USB dongle device of claim 1 further comprising:
an input/output (I/O) module, coupled to the USB interface, for generating the second data based on actions of a user.

12. The USB dongle of claim 1 wherein the wireless millimeter wave transceiver and the USB interface are powered by a current received from the host device via the USB interface.

13. The USB dongle device of claim 1 wherein the USB interface includes:
a USB plug for connecting to the host device; and
a USB controller circuit coupled to format outbound data included in the second data in the USB format for communication to the host device and to recover inbound data from second data received in the USB format from the host device.

14. The USB dongle device of claim 13 further comprising:
a housing coupled to support the wireless millimeter wave transceiver, the USB plug and the USB controller circuit, wherein the housing conforms to a USB flash drive form factor.

15. The USB dongle device of claim 14 wherein the USB dongle further comprises:
a cap that is couplable with the housing in a first position to cover the USB plug when not in use.

16. The USB dongle device of claim 15 wherein the cap is couplable with the housing in a second position to store the cap and to leave the USB plug uncovered.

17. The USB dongle device of claim 15 wherein the cap includes an opening for accepting a key ring.

18. The USB dongle device of claim 15 wherein the housing includes an opening for accepting a key ring.

19. A universal serial bus (USB) dongle device comprising:
a memory module;
a wireless millimeter wave transceiver that communicates first data between the memory module and the a host device via an RF millimeter wave communication path;
an input/output (I/O) module that generates second data based on actions of a user; and
a USB interface, coupled to the I/O module, that when coupled to a host device, communicates the second data with the host device.

20. The USB dongle of claim 1 wherein the wireless millimeter wave transceiver and the USB interface are powered by a current received from the host device via the USB interface.

21. The USB dongle device of claim 1 wherein the USB interface includes:
a USB plug for connecting to the host device; and
a USB controller circuit coupled to format outbound data included in the second data in the USB format for communication to the host device and to recover inbound data from second data received in the USB format from the host device.
